(19) United States
(12) Patent Application Publication
(10) Pub. No.: US 2004/0190213 A1
(43) Pub. Date: Sep. 30, 2004

(54) Compensation circuit for power supply

(76) Inventor: Kuo-Liang Lin, Chia-Yi Hsien (TW)

Correspondence Address: BIRCH STEWART KOLASCH & BIRCH, PO BOX 747, FALLS CHURCH, VA, 22040-0747, US

(21) Appl. No.: 10/394,158

(22) Filed: Mar. 24, 2003

(51) Int. Cl. H02H 9/00

(52) U.S. Cl. 361/118

(57) ABSTRACT

A compensation circuit for a power supply comprises a compensation component connected in parallel to a PFC choke used by a rectification unit of a power supply, said compensation component lets the current through the PFC choke pass through the compensation component (charging the compensation component) before the current is connected due to the counter electromotive force effect, and brings the angle of current connection forward (which is the operating phased current of the compensation current), and discharges the PFC choke when the compensation component is at the antiphase of the voltage; such charging current and discharging current are equal (balanced) and thus improving the completeness of the current waveform.

### FIELD OF THE INVENTION

The present invention relates to a compensation circuit, more particularly to a circuit enables the current of the PFC choke used by a rectification unit of a power supply to be connected ahead of the time.

### BACKGROUND OF THE INVENTION

Since the rectification unit inside a switching power supply (S.P.S.) that is commonly used in the present market has a capacitor C₅, C₆ as shown in FIG. 6, therefore it belongs to a load of electric capacity, and is unable to pass the harmonics test according to the European specification IEC100-3-2. In order to improve the harmonics of the S.P.S., a choke as indicated by L1 in FIG. 6 is generally added to a rectification unit of the S.P.S to improve the harmonics. Such choke is also called PFC choke. Since the interior space of a S.P.S. of desktop computers is quite limited and the volume of the PFC choke is not small at all, therefore if the PFC choke used in a power supply is one with a small number of wattage (below 250 W), the PFC choke can be installed in the power supply, but if the PFC choke is the one used for over 300 W, the volume of the PFC choke becomes relatively large, and it is quite difficult to install the PFC choke in the housing of the power supply.

Further, when the input voltage source enters the PFC choke, the PFC choke itself will produce a counter electromotive force at the beginning to keep the current I₁ from entering, and thus creating a situation with the current phase falling behind the voltage phase. When the current I₁ starts initializing, its phase will produce a current with relatively large pulse (as shown in the waveform S₁ in FIG. 7) due to the smaller angle of its phase. The pulse of such current will generate a magnetic saturation to the PFC choke. It will cause an antiphase to the current (as shown in the waveform S₁ in FIG. 7). If the input voltage is in an antiphase and the magnetic saturation of the first half wave has a larger magnetism remained in the magnetic core such that the magnetic hysteresis curve of the whole iron core deviates from the center, it will reduces the antiphase current (as shown in the waveform S₂ in FIG. 7). Therefore, the currents S1 and S2 so produced are not balanced, and thus the average current flow (Ampere Root Mean, ARM) rises obviously, such that the completeness of the waveform will lose its originality due to the damage created by the uneven current flows of the two phases. The extent of losing originality becomes more serious as the load increases, therefore when the wattage of the S.P.S. is increased, the effective cross-sectional area of the PFC choke must be increased to prevent the phenomenon of losing originality. In other words, the volume of the PFC choke has to be increased, and thus consuming more silicon steel sheets and copper wires.

### SUMMARY OF THE INVENTION

The primary objective of the present invention is to solve the aforementioned problems and eliminate the drawbacks of cited prior art by using a simple design to enhance the characteristic of the PFC choke and improve the harmonics performance and provide a more stable output for the power supply.

To achieve the foregoing objective, the PFC choke is connected to a compensation circuit in parallel, said compensation component lets the current through the PFC choke pass through the compensation component (charging the compensation component) before the current is connected due to the counter electromotive force effect, and brings the angle of current connection forward (which is the operating phased current of the compensation current), and discharges the PFC choke when the compensation component is at an antiphase of the voltage; such charging current and discharging current are equal (balanced) and thus improving the completeness of the current waveform.

### BRIEF DESCRIPTION OF THE DRAWINGS

To provide a further understanding of the invention, the following detailed description illustrates embodiments and examples of the invention, this detailed description being provided only for illustration of the invention.

FIG. 1 is a block diagram of the rectification unit of the power supply according to the present invention.

FIG. 2 is a circuit diagram of the rectification unit of the power supply as shown in FIG. 1.

FIG. 3 is an illustrative diagram of the waveform measured from the rectification unit when connected to the compensation component according to the present invention.

FIG. 4A is an illustrative diagram of the waveform measured from the rectification unit when connected to the compensation component and having the highest power according to the present invention.

FIG. 4B is an illustrative diagram of the waveform measured from the rectification unit when not connected to the compensation component and having the highest power according to the prior art.

FIG. 5A is an illustrative diagram of the waveform measured from the rectification unit when connected to the compensation component and having the lowest power according to the present invention.

FIG. 5B is an illustrative diagram of the waveform measured from the rectification unit when not connected to the compensation component and having the lowest power according to the prior art.

FIG. 6 is a circuit diagram of the prior-art rectification unit.

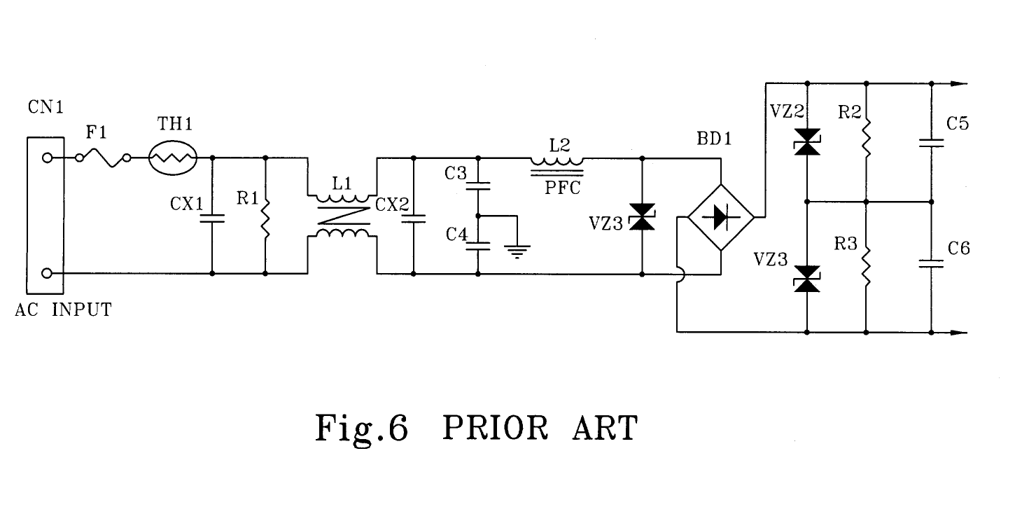

FIG. 7 is an illustrative diagram of the waveform measured from the prior art rectification unit when not connected to the compensation unit.

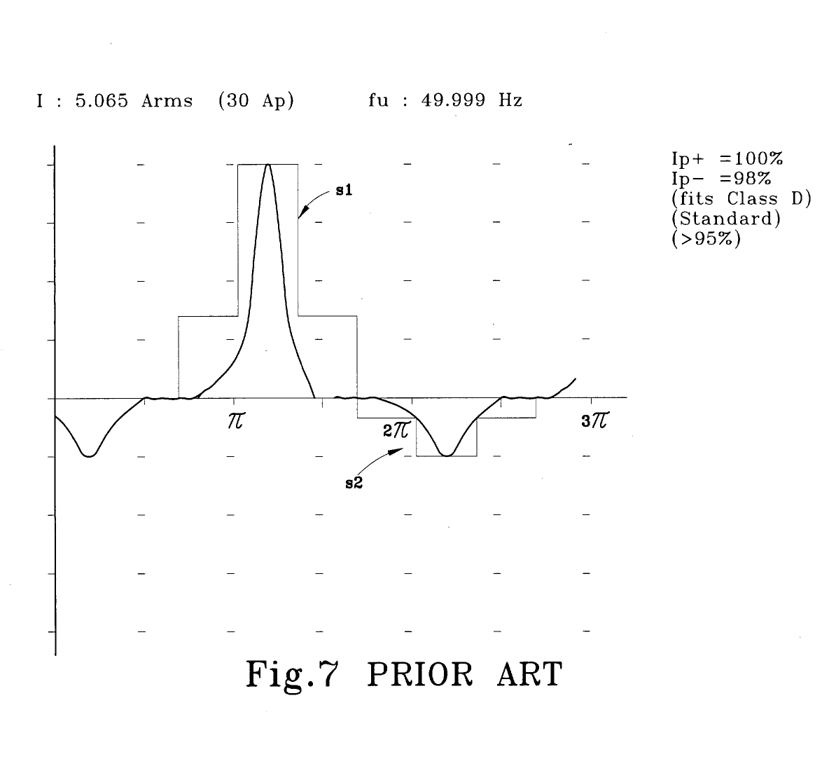

### DETAILED DESCRIPTION OF THE PREFERRED EMBODIMENTS

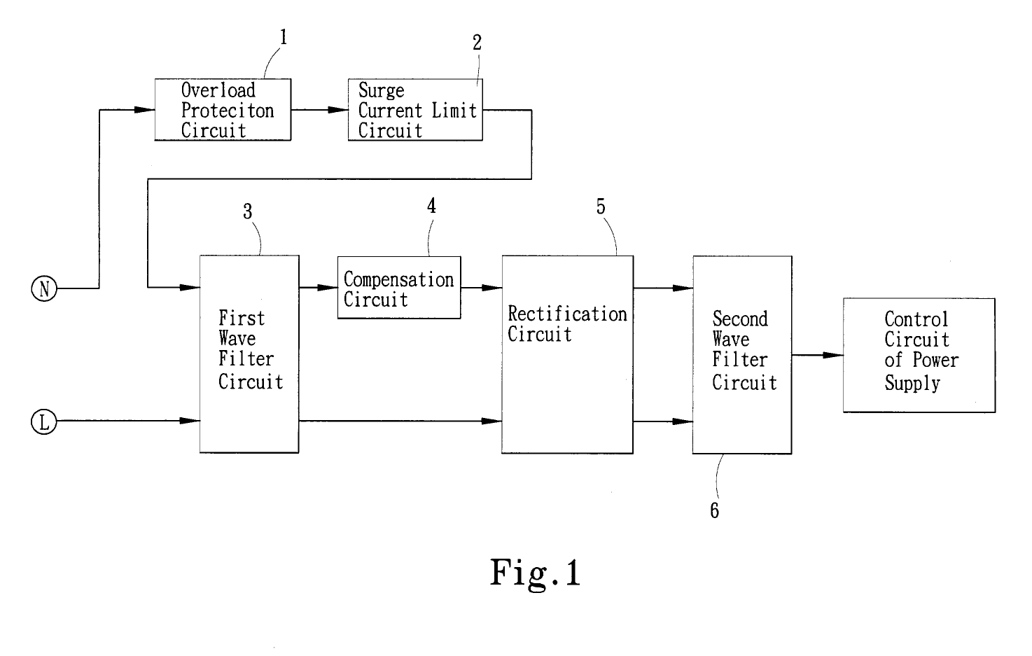

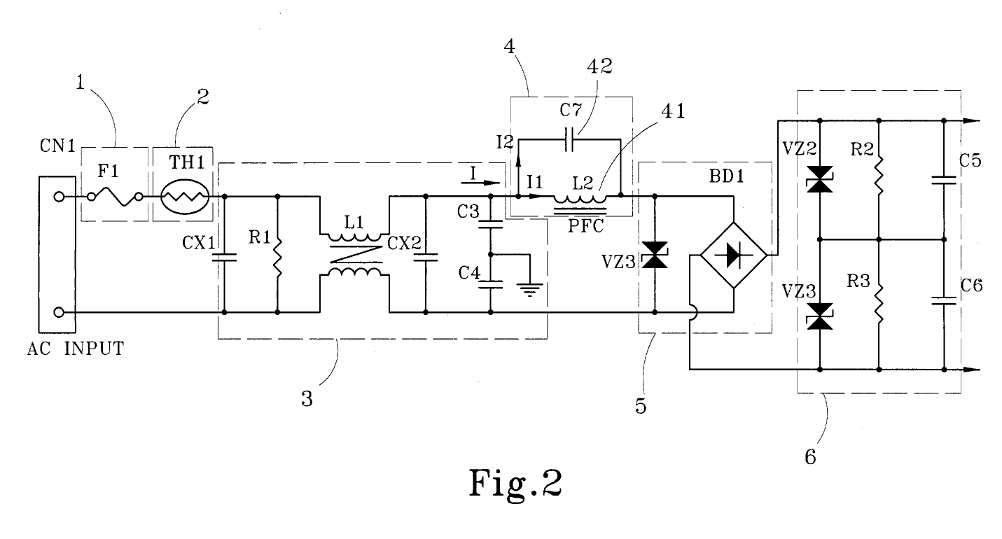

Please refer to FIGS. 1 and 2 for the block diagram and the circuit diagram of the power supply rectification circuit of a power supply according to the present invention. In the figures, the compensation circuit of the power supply in accordance with the present invention is set onto a power supply rectification unit of the power supply for compensating the phase of the power supply, enhancing the PFC choke (choke for correcting the power factor), improving the harmonics performance of the PFC choke, and letting the power supply rectification unit have a better output voltage to be sent to the control circuit of the power supply.

The above-mentioned power supply rectification unit comprises an overload protection circuit 1, a surge limit circuit 2, a first wave filter circuit 3, a compensation circuit 4, a rectification circuit 5, and a second wave filter 6. Since the foregoing power supply rectification unit is a prior art, therefore the operation theory of the power supply rectification unit will not be described here, and only the operation theory of the foregoing compensation circuit 4 is described as follows.

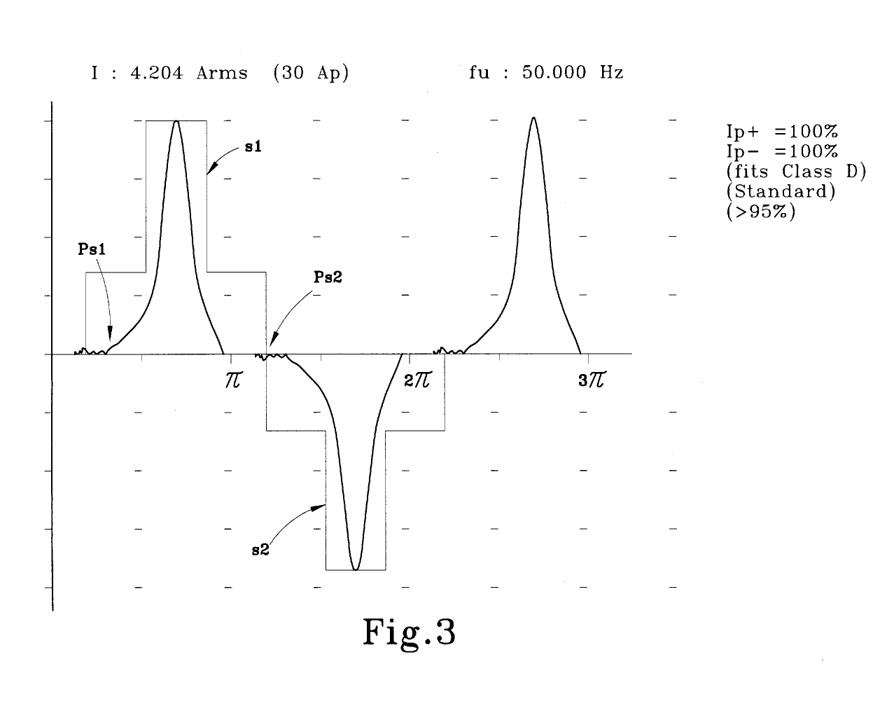

Said compensation circuit comprises a PFC choke 41 and a compensation component 42 connected to said PFC choke 41 in parallel; wherein said compensation component 42 could be but not limited to a capacitor, and the input end of said compensation circuit 4 is coupled to the output end of the first wave filter circuit 3 and the output end of said compensation circuit 4 coupled to the input end of the rectification circuit 5. When a current I₁ is outputted from the first wave filter circuit 3, said compensation component 42 allows the current I₁ at the PFC choke 41 to pass the I₂ current through the compensation component 42 first due to counter electromotive force effect before being electrically connected (charging the compensation component 42) and brings the current connection angle forward (as shown in the Psi in FIG. 3, which is a phase current when the compensation component 42 is operating). After the compensation component 42 is charged and when the voltage is in an antiphase, the electric power stored in the PFC choke 41 is discharged; such electric power is exactly the antiphase of the previous phase, therefore it can reset the remained magnetism in the magnetic core (silicon steel sheet), keep the hysteresis curve from being deviated and the phases of current S₁ and S₂ balanced, and improve the completeness of the current waveform.

Please refer to FIG. 3 for the illustrative diagram of the waveform detected from the compensation component connected to the rectification unit of the present invention. In the figure, after the PFC choke of the power supply rectification unit of the present invention is connected to a compensation component 42 in parallel, the current waveforms S1 and S2 are equal and balanced. Therefore the ampere root mean (ARM) is lower.

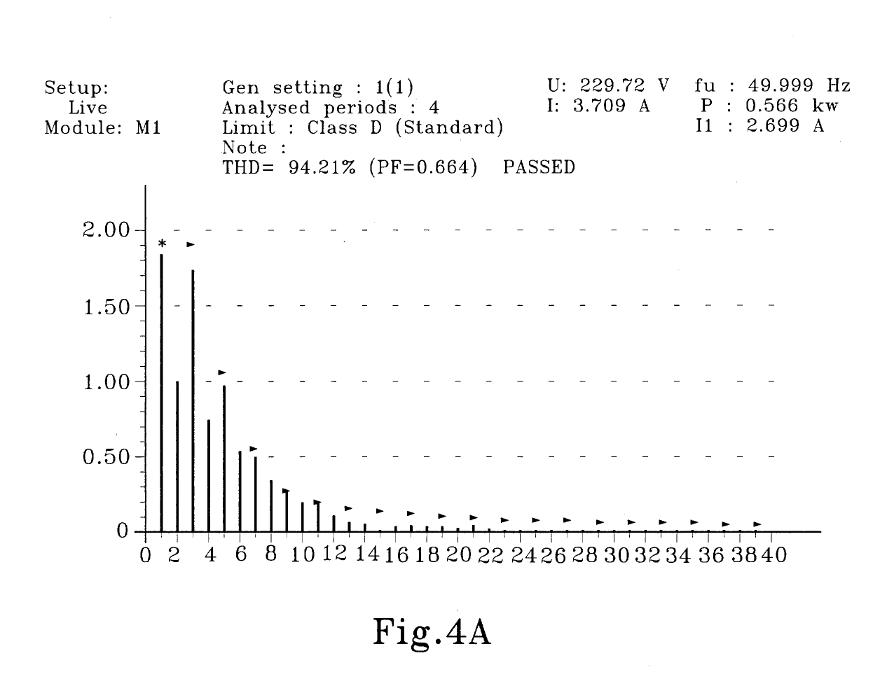

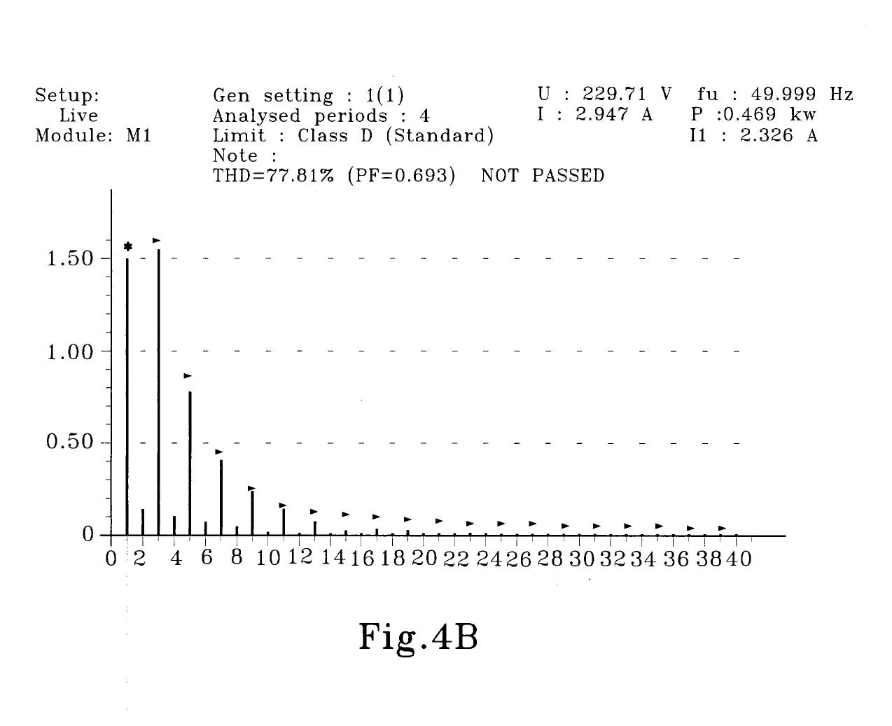

Please refer to FIGS. 4A and 4B for the illustrative diagrams of the rectification unit connected to the compensation component having the highest detected power and of the rectification unit not connected to the compensation component having the highest detected power. In the figures, after the rectification unit of the PFC choke 41 of the present invention is connected to a compensation component 42 in parallel, the detected upper limit value of the power is up to 566 W, which can still meet the European specification IEC1000-3-2 Class-D.

If the prior-art rectification unit of the PFC choke is not connected to a compensation component, the detected upper limit value of the power of the power supply is up to 469 W, which cannot meet the European specification IEC1000-3-2 Class-D.

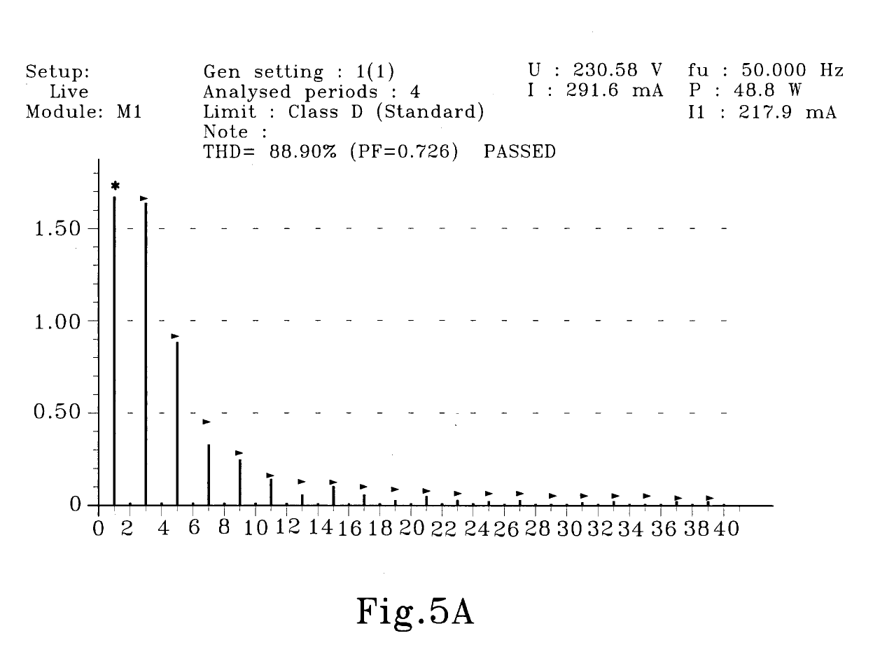

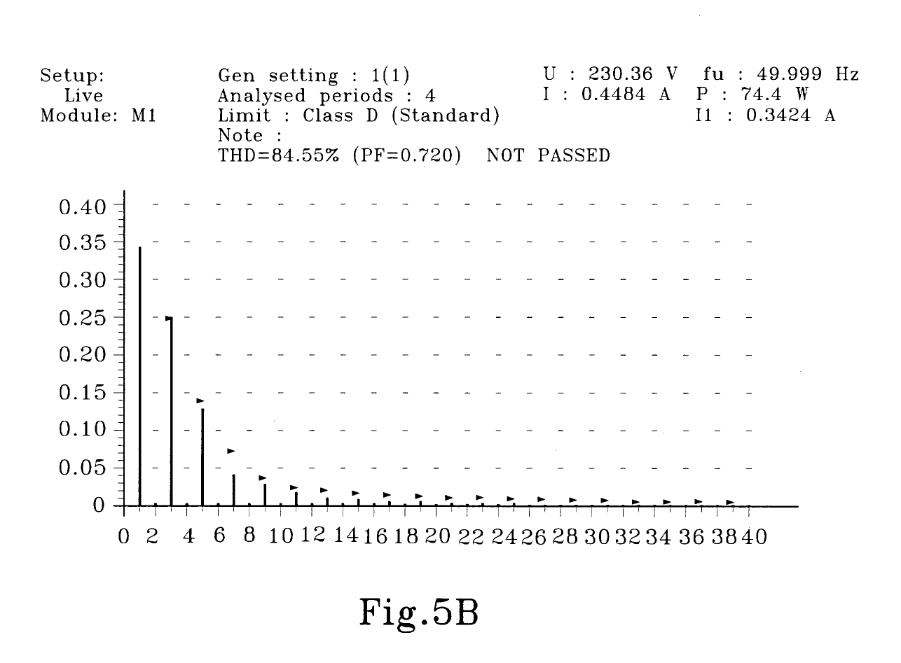

Please refer to FIGS. 5A and 5B for the illustrative diagrams of the rectification unit connected to the compensation component having the lowest detected power and of the prior-art rectification unit not connected to the compensation component having the lowest detected power. In the figures, after the PFC choke 41 of the rectification unit of the present invention is connected to a compensation component 42, the lower limit value of the power detected is up to 48.8 W, which can still pass the standard of European specification IEC1000-3-2 Class-D.

If the prior-art PFC choke of the rectification unit is not connected to a compensation component, the lower limit value of the power detected from the power supply is up to 74.6 W or 74.4 W, then it cannot pass the standard of the European specification IEC1000-3-2 Class-D.

Further, the design of the rectification unit of the power supply adds a compensation component that does not occupy any additional interior space in the housing of the power supply, and also maintains the original design of the interior of the power supply.

While the present invention has been described in connection with what is considered the most practical and preferred embodiment, it is understood that the invention is not limited to the disclosed embodiments but is intended to cover various modifications and similar arrangements included within the spirit and scope of the broadest interpretation and equivalent arrangements.

What is claimed is:

1. A compensation circuit for power supply, wherein a rectification unit of the power supply comprising an overload protection circuit, a surge current limit circuit, a first wave filter circuit, a PFC choke, a rectification circuit, and a second wave filter circuit, characterized in that said PFC choke being connected in parallel to a compensation circuit; said compensation component allowing the current through the PFC choke to pass the compensation component (charging the compensation component) first before the current being connected due to the counter electromotive force effect; bringing the current connection angle forward (as the operating phase current of the compensation component); discharging the PFC choke when the compensation component being in the antiphase of the voltage; and said charging and discharging being equal (balanced) to improve the completeness of the current waveform.

2. The compensation circuit for power supply of claim 1, wherein said compensation component is a capacitor.

3. The compensation circuit for power supply of claim 1, wherein said compensation component is discharged such that the discharged electric energy being an antiphase of the previous phase, and thus resetting the magnetism remained in a magnetic core (silicon steel sheet), preventing the hysteresis curve from being deviated, and equalizing (balancing) the phases of the charging and discharging currents.
